(19) United States
(12) Patent Application Publication
(10) Pub. No.: US 2012/0129017 A1
(43) Pub. Date: May 24, 2012

(54) BATTERY PACK AND MANUFACTURING METHOD THEREOF

(75) Inventor: Shinji Ota, Osaka (JP)

(73) Assignee: PANASONIC CORPORATION, Osaka (JP)

(21) Appl. No.: 13/386,802

(22) PCT Filed: Jan. 18, 2011
(86) PCT No.: PCT/JP2011/000220

§ 371 Date: Jan. 24, 2012

(30) Foreign Application Priority Data
Feb. 2, 2010 (JP) 2010-021117

(51) Int. Cl. H01M 10/42; H01M 10/04

(52) U.S. Cl. 429/7; 29/623.1; 29/623.2

(57) ABSTRACT

A battery pack and a manufacturing method thereof enabling the streamlining of assembly work are provided. This battery pack comprises a printed circuit board 6 including wiring, lead plates 7, 10 that are fixed to the printed circuit board 6 and that electrically connect the wiring of the printed circuit board 6 and both electrodes 4, 5 of a battery 2, and a screw 12 that presses the lead plates 7, 10 so as to maintain a state of electrically connecting of the lead plates 7, 10 to both electrodes 4, 5 of the battery 2 by being screwed into the battery 2.

### TECHNICAL FIELD

The present invention relates to a battery pack mounted with a safety member for controlling a circuit so as to inhibit the occurrence of thermal runaway and internal short circuits when a cause of overcharge, overdischarge or the like is detected.

### BACKGROUND ART

Generally speaking, a battery pack comprising a battery, and a safety member for inhibiting the occurrence of thermal runaway and internal short circuits of the battery is known. The safety member comprises a substrate, and a connecting member provided between the substrate and the battery and which is used for electrically connecting the substrate and the battery pole.

For example, Patent Document 1 discloses a battery pack comprising a bare cell (battery), first and second electrode leads (connecting members) coupled to first and second electrode terminals (poles) of the bare cell, and a protective circuit board (substrate) which is electrically connected to the bare cell via the first and second electrode leads. The first and second electrode leads (connecting members) are respectively welded to the first and second electrode terminals (poles) of the bare cell (battery).

Moreover, the connection between the connecting member and the substrate is also generally realized via welding.

Nevertheless, when manufacturing a battery pack in which the connecting member, which is disposed between the substrate and the battery, is welded to both the substrate and the battery, it is necessary to sequentially weld the substrate and the battery to the side that is opposite to the connecting member. Thus, there is a problem in that it is difficult to improve the efficiency of the assembly work.

Patent Document 1: Japanese Patent Application Publication No. 2008-177156 (in particular paragraph [0036])

### SUMMARY OF THE INVENTION

Thus, an object of this invention is to provide a battery pack and its manufacturing method capable of streamlining the assembly work.

In order to achieve the foregoing object, the present invention provides a battery pack comprising a battery, and a safety member that includes a circuit connected to the battery and that controls the circuit when a predetermined cause is detected, wherein the safety member has: a substrate including wiring which configures at least a part of the circuit; a connecting member that is fixed to the substrate and that electrically connects the wiring and a pole of the battery; and a screw that maintains an electrically connected state of the connecting member to the pole of the battery by being screwed into a predetermined screw target.

Moreover, the present invention provides a method of manufacturing a battery pack, including a first fixing step of fixing a connecting member and a substrate so that wiring formed on the substrate and the connecting member are electrically connected, an arranging step of arranging the connecting member fixed to the substrate at a position where the connecting member is electrically connected to a pole of battery, a mounting step of mounting a cover member on the battery so as to cover the substrate and the connecting member arranged in the arranging step, and a second fixing step of fixing the cover member to the battery by screwing a screw into the battery through the cover member mounted on the battery, wherein, in the second fixing step, a state of electrically connecting the connecting member to the pole of battery is maintained by pressing the connecting member to the battery side via the cover member in accordance with the screwing of the screw.

In addition, the present invention provides a method of manufacturing a battery pack, including a first fixing step of fixing a connecting member and a substrate so that wiring formed on the substrate and the connecting member are electrically connected, an arranging step of arranging the connecting member fixed to the substrate at a position where the connecting member is electrically connected to a pole of battery, a mounting step of mounting a cover member on the battery so as to cover the substrate and the connecting member arranged in the arranging step, a second fixing step of fixing the battery and the cover member so as to restrict the battery and the cover member from moving in a direction of mutual separation, and a screwing step of screwing a screw through the cover member fixed to the battery, and wherein, in the screwing step, a state of electrically connecting of the connecting member to the pole of the battery is maintained by pressing the connecting member to the battery side in accordance with the movement of a tip part of the screw.

### BRIEF DESCRIPTION OF THE DRAWINGS

FIG. 1 is a perspective view showing the overall configuration of the battery pack according to an embodiment of the present invention.

FIG. 2 is a cross section of line II-II of FIG. 1.

FIG. 3 is a cross section showing a modified example of the lead plate in accordance with the embodiment of FIG. 1.

FIG. 4 is a cross section showing a modified example of the lead plate in accordance with the embodiment of FIG. 1.

FIG. 5 is a diagram corresponding to FIG. 2 according to another embodiment of the present invention.

FIG. 6 is a cross section showing an enlarged portion of FIG. 5.

FIG. 7 is a diagram corresponding to FIG. 2 in accordance with yet another embodiment of the present invention.

### DESCRIPTION OF EMBODIMENTS

Embodiments of the present invention are now explained with reference to the appended drawings. Note that the following embodiments are examples which embody the present invention, and are not intended to limit the technical scope of the present invention.

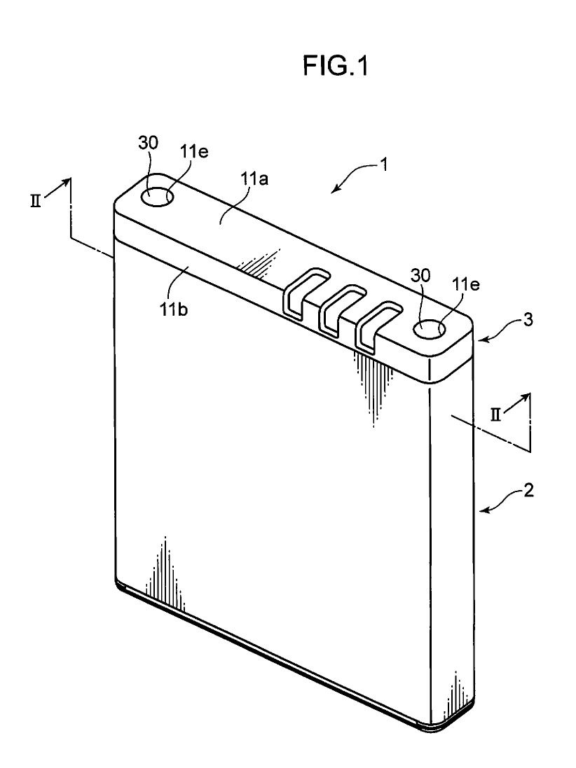

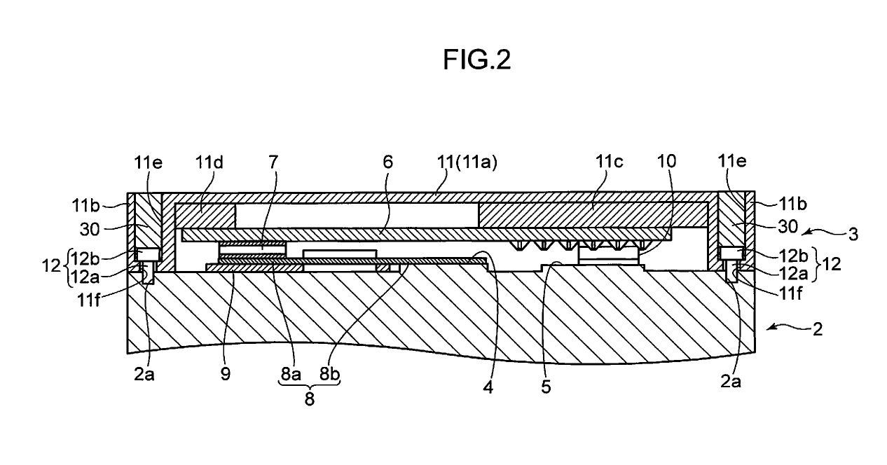

FIG. 1 is a perspective view showing the overall configuration of the battery pack according to an embodiment of the present invention. FIG. 2 is a cross section of line II-II of FIG. 1.

Referring to FIG. 1 and FIG. 2, a battery pack 1 comprises a laminar battery 2, and a safety member 3 fixed to an end face (upper face of FIG. 1) facing a direction (hereinafter referred to as the “vertical direction”) which is orthogonal to the thickness direction (hereinafter referred to as the “horizontal direction”) of the battery 2.

The battery 2 is a lithium ion battery. The battery 2 includes a negative electrode 4 and a positive electrode 5 formed on an end face facing upward. The negative electrode 4 and the positive electrode 5 are respectively arranged side by side in the horizontal direction. Moreover, a pair of female screw parts 2a opening upward is formed at the left and right edges of the upper end face of the battery 2. In this embodiment, the battery 2 corresponds to the screw target of the screw 12 described later.

The safety member 3 includes a circuit connected to the battery 2, and controls the circuit when a predetermined temperature (cause) is detected. Specifically, the safety member 3 comprises, as shown in FIG. 2, a printed circuit board 6 printed with wiring (not shown) configuring at least a part of the circuit, lead plates (connecting members) 7, 10 for electrically connecting the printed circuit board 6 and the battery 2, a control member 8 for controlling the circuit when a predetermined temperature is detected, an insulating plate 9 provided between the control member 8 and the battery 2, a cover member 11 which covers the printed circuit board 6, the lead plates 7, 10, the control member 8 and the insulating plate 9, and a pair of left and right screws 12, 12 for fixing the cover member 11 and the battery 2.

The lead plates 7, 10 are respectively configured by one metal plate being folded back into a U-shape in the depth direction of FIG. 2 in a manner of being able to elastically deform vertically. The upper fold-back part of the respective lead plates 7, 10 is welded (fixed) to the printed circuit board 6. Moreover, the lower fold-back part of the lead plate 7 is electrically connected to the control member 8 described later. Meanwhile, the lower fold-back part of the lead plate 10 is electrically connected to the positive electrode 5 of the battery 2.

The control member 8 comprises a lead part 8a which is electrically connected to the lead plate 7, and a functional element 8b which is electrically connected to the lead part 8a. The functional element 8b is made of bimetal or the like, deforms when the temperature inside the safety member 3 becomes a predetermined temperature, and switches the posture of the battery 2 from a state of being contact with the negative electrode 4 to a state of being separated from the negative electrode 4.

The insulating plate 9 is provided between the lead part 8a and functional element 8b of the control member 8, and the upper end face of the battery 2, and thereby prevents the short circuit of the lead part 8a, the functional element 8b and the battery 2.

The cover member 11 is made of synthetic resin. The cover member 11 comprises a top plate 11a of a size that corresponds to the upper end face of the battery 2, a side wall 11b that extends downward from the peripheral edge of the top plate 11a, a pair of left and right supporting parts 11c, 11d provided on the inside of the side wall 11b, and a counterbore 11e and a through-hole 11f provided to the side wall 11b. The cover member 11 is mounted on the battery 2 in a state where the lower end face of the side wall 11b is in contact with the upper end face of the battery 2. The supporting parts 11c, 11d respectively extend across the top plate 11a and the side wall 11b and protrude downward from the top plate 11a. The supporting parts 11c, 11d have a protruding size of coming in contact with the upper face of the printed circuit board 6 so that the printed circuit board 6 is pressed to the battery 2 side until the lead plates 7, 10 become an elastically deformed state when the cover member 11 is mounted on the battery 2. The through-hole 11f penetrates the cover member 11 (side wall 11b) vertically, and a male screw part 12a of the screw 12 is inserted therethough. The counterbore 11e has an opening area of a size that is greater than the through-hole 11f at the upper part of the through-hole 11f. Accordingly, a head part 12b of the screw 12 in which the male screw part 12a was inserted through the through-hole 11f is housed in the counterbore 11e.

The screw 12 penetrates the cover member 11 from top to bottom through the through-hole 11f, and its tip part (male screw part 12a) screws with a female screw part 2a of the battery 2. Consequently, the screw 12 fixes the cover member 11 and the battery 2. As shown in FIG. 2, in a state where the screw 12 is screwed into the battery 2, the printed circuit board 6 is pressed to the battery 2 side by the supporting parts 11c, 11d of the cover member 11. Consequently, the lead plate 7 is subject to elastic deformation between the printed circuit board 6 and the control member 8 (lead part 8a), and the lead plate 10 is subject to elastic deformation between the printed circuit board 6 and the battery 2 (positive electrode 5). In addition, based on the screwing of the screw 12, the electrically connected state between the lead plate 7 and the control member 8 is maintained, and the electrically connected state between the lead plate 10 and the battery 2 is maintained.

The counterbore 11e of the cover member 11 is provided with a restrictive member (restrictive means) 30. The restrictive member 30 restricts the contact to the screw 12, which was screwed into the battery 2, from the outside of the cover member 11. Specifically, the restrictive member 30 is made from an adhesive material that was filled and hardened in the counterbore 11e. It is also possible to adopt a cover member which covers the counterbore 11e as the restrictive member 30.

The method of manufacturing the battery pack 1 is now explained.

Referring to FIG. 2, foremost, the printed circuit board 6 and the respective lead plates 7, 10 are welded so that the wiring of the printed circuit board 6 and each of the lead plates 7, 10 are electrically connected (first fixing step).

Subsequently, the insulating plate 9 is mounted on the upper face of the battery 2, and the control member 8 is mounted on the insulating plate 9 so that the functional element 8b of the control member 8 and the negative electrode 4 of the battery 2 are electrically connected.

In addition, the lead plates 7, 10 are arranged (mounted) on the battery 2 so that the lead plate 7 comes in contact with the lead part 8a of the control member 8, and the lead plate 10 comes in contact with the positive electrode 5 of the battery 2 (arranging step).

The cover member 11 is mounted on the upper end face of the battery 2 so as to cover the printed circuit board 6 and the respective lead plates 7, 10 mounted on the battery 2 (mounting step). In addition, the cover member 11 and the battery 2 are fixed by screwing the screw 12 (second fixing step).

In this second fixing step, the respective lead plates 7, 10 are pressed to the battery 2 side via the cover member 11 in accordance with the screwing of the screw 12. The electrically connected state of the respective lead plates 7, 10 to both electrodes 4, 5 of the battery 2 is thereby maintained.

In addition, an adhesive material serving as the restrictive member 30 is filled in the counterbore 11e of the cover member 11. Consequently, the adhesive material that hardened in the counterbore 11e restricts the contact to the screw 12 from the outside of the cover member 11.

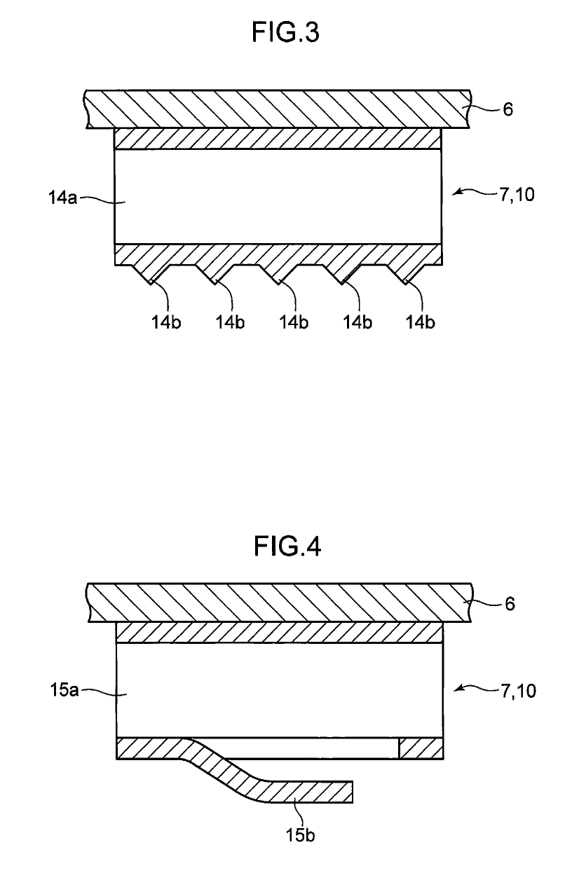

Note that, in the foregoing embodiment, the respective lead plates 7, 10 having a flat lower face were explained, the lead plates 7, 10 as shown in FIG. 3 and FIG. 4 can also be adopted.

Specifically, the lead plates 7, 10 shown in FIG. 3 include a body part 14a formed by one metal plate being folded back in a U-shape, and a plurality of protruding parts 14b protruding from the lower face of the lower fold-back part of the body part 14a to the battery 2 side. The protruding parts 14b have a cross section in the shape of a substantial isosceles triangle.

In the case of adopting the lead plates 7, 10 shown in FIG. 3, it is possible to cause the protruding parts 14b protruding from the body part 14a to actively come in contact with the battery 2 or the control member 8 while the body part 14a, which is formed by folding back a metal plate, is subject to elastic deformation. Moreover, the contact area of the lead plates 7, 10 shown in FIG. 3 relative to the battery 2 or the control member 8 is smaller than the contact area of the lead plates 7, 10 shown in FIG. 2. Thus, the contact pressure of the respective lead plates 7, to the battery 2 or the control member 8 can be increased.

Moreover, the lead plates 7, 10 shown in FIG. 4 include a body part 15a formed by folding back one metal plate in a U-shape, and a tongue part (protruding part) 15b protruding downward from the lower fold-back part of the body part 15a. The tongue part 15b is formed by punching out a part of the metal plate configuring the body part 15a. Moreover, the tongue part 15b functions as a plate spring by being folded back downward from the body part 15a.

In the case of adopting the lead plates 7, 10 shown in FIG. 4, it is possible to cause the tongue part 15b to actively come in contact with the battery 2 or the control member 8 while the body part 15a and the tongue part 15b, which are formed by folding back the metal plate, are subject to elastic deformation. Note that the body part 15a and the tongue part 15b respectively possess the function of elastic deformation. Here, from the perspective of omitting the elastic deformation function of the body part 15a, it is also possible to adopt lead plates in which the tongue part 15b is provided to a flat metal plate that is not folded back in a U-shape in substitute for the respective lead plates 7, 10.

As explained above, according to the foregoing embodiment, it is possible to maintain the electrically connected state of the lead plates 7, 10 and the battery 2 based on the screwing of the screw 12. Thus, it is possible to streamline the assembly work of the battery pack 1. Specifically, the connected state of the lead plate 7 and the control member 8 and the connected state of the lead plate 10 and the battery 2 can be maintained by fixing the printed circuit board 6 and the lead plates 7, 10 in advance and screwing them with the screw 12. It is thereby possible to eliminate the complicated process of welding the upper side and lower side (battery 2 side and printed circuit board 6 side) of the lead plates 7, 10, and streamline the assembly work.

In the foregoing embodiment, the lead plates 7, 10 are pressed to the battery 2 side in accordance with the screwing of the screw 12 which fixes the cover member 11 and the battery 2. Consequently, the screw 12 for pressing the lead plates 7, 10 to the battery 2 side can also be used for fixing the cover member 11 and the battery 2. Thus, the number of parts can be reduced.

In the foregoing embodiment, a restrictive member 30 for restricting contact to the head part 12b of the screw 12 from the outside of the cover member 11 is provided. It is thereby possible to inhibit the operation of loosening the screw 12 from the outside of the cover member 11. Accordingly, the electrically connected state of the lead plates 7, 10 and the battery 2 can be maintained more effectively.

In the foregoing embodiment, the lead plates 7, 10 can be elastically deformed. Consequently, the lead plates 7, 10 are pressed to the battery 2 side in an elastically deformed state based on the screwing of the screw 12. Thus, even in cases where the distance between the lead plates 7, 10 and the counterpart member (control member 8, positive electrode 5 of the battery 2) is changed such as when impact is applied to the battery pack 1, the lead plates 7, 10 are subject to elastic deformation in accordance with such change. It is thereby possible to reliably maintain the electrically connected state.

In the foregoing embodiment, the lead plates 7, 10 include a body part 14a and a protruding part 14b protruding from the body part 14a (refer to FIG. 3). Consequently, by pressing the lead plates 7, 10 to the battery 2 side, the protruding part 14b can be caused to actively come in contact while preventing an unintended portion of the lead plates 7, 10 (body part 14a) from coming in contact with the counterpart member (control member 8, battery 2). Moreover, in the foregoing embodiment, the contact area can be decreased by causing the protruding part 14b, which is a part of the lead plates 7, 10, to come in contact with the counterpart member in comparison to the case of causing the entire lead plates 7, 10 to come in contact. Thus, the contact pressure of the lead plates 7, 10 and the counterpart member can be increased.

In the foregoing embodiment, a control member 8 is provided. Consequently, the thermal runaway and the like of the battery 2 can be inhibited by electrically disconnecting the battery 2 and the printed circuit board 6 by the control member 8 when the temperature of the battery 2 becomes a predetermined temperature or higher. In addition, the lead plate 7 and the battery 2 can be electrically connected via the control member 8.

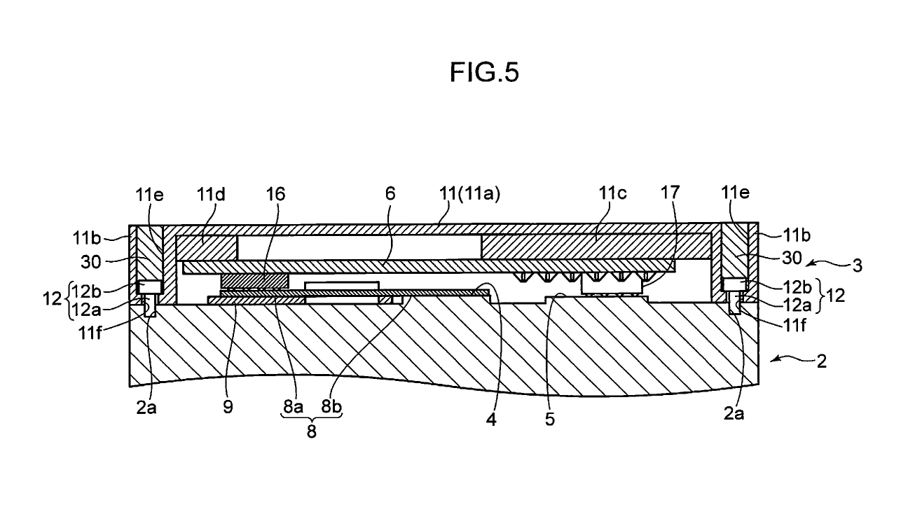

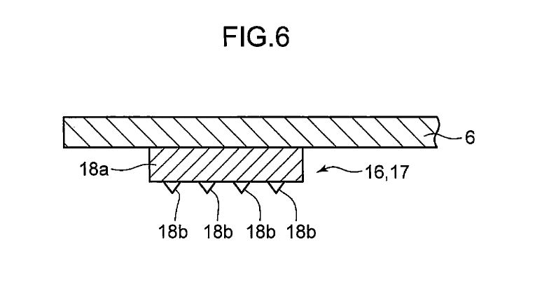

Another embodiment of the present invention is now explained with reference to FIG. 5 and FIG. 6.

FIG. 5 is a diagram corresponding to FIG. 2 according to another embodiment of the present invention. FIG. 6 is a cross section showing an enlarged portion of FIG. 5. Note that the same configuration as the foregoing embodiment will be given the same reference numeral and the explanation thereof is omitted.

The battery pack according to this embodiment differs from the foregoing embodiment with respect to the point of having connecting terminals 16, 17 in substitute for the respective lead plates 7, 10. The connecting terminals 16, 17 include a body part 18a mounted on the lower face of the printed circuit board 6, and a plurality of protruding parts 18b protruding from the lower face of the body part 18a to the battery 2 side. The respective protruding parts 18b are electrically connected to wiring on the printed circuit board 6 via a lead part not shown.

In this embodiment also, the connecting terminals 16, 17 are pressed to the battery 2 side via the cover member 11 in accordance with the screwing of the screw 12 with the female screw part 2a of the battery 2. The electrically connected state of the respective protruding parts 18b of the connecting terminals 16, 17 to the battery 2 or the control member 8 is thereby maintained by the screw 12.

Moreover, in this embodiment also, the connecting terminals 16, 17 include the protruding parts 18b protruding to the battery 2 side. Thus, the protruding part 18b can be caused to actively come in contact while preventing an unintended portion (for example, body part 18a) of the connecting terminals 16, 17 from coming in contact with the counterpart member (control member 8, battery 2). Moreover, in the foregoing embodiment, the contact area can be decreased by causing the protruding part 18b, which is a part of the connecting terminals 16, 17, to come in contact with the counterpart member (control member 8, battery 2) in comparison to the case of causing the entire connecting terminals 16, 17 to come in contact. Thus, the contact pressure of the connecting terminals 16, 17 and the counterpart member can be increased.

Furthermore, in this embodiment, the connecting terminals 16, 17 are adopted in substitute for the lead plates 7, 10 (refer to FIG. 2) according to the foregoing embodiment. Thus, there are the following advantages.

Since electrical connection can be easily achieved merely by assembly, it is possible to simply the process and provide a battery pack structure that is suitable for automation. In addition, as a result of omitting spot welding, it is possible to realize the reduction of equipment and man-hours, and additionally contribute to the energy reduction.

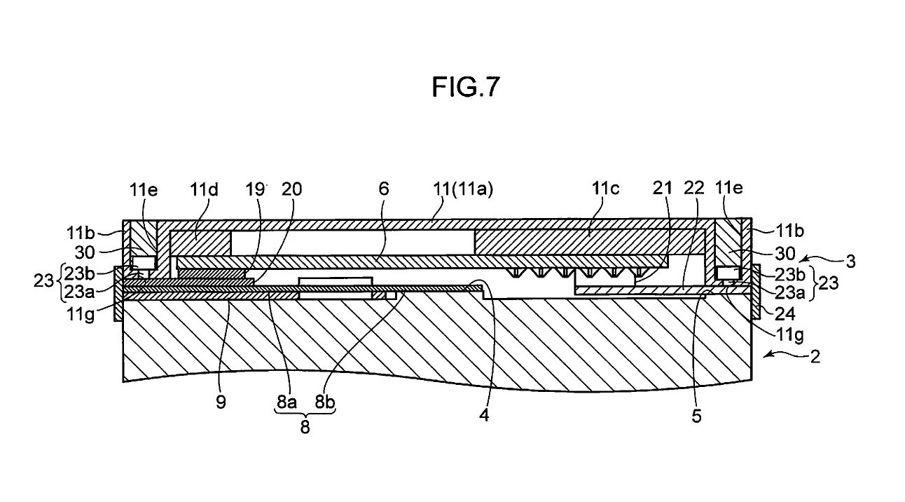

FIG. 7 is a diagram corresponding to FIG. 2 in accordance with yet another embodiment of the present invention. Note that the same configuration as each of the foregoing embodiments will be given the same reference numeral and the explanation thereof is omitted.

Referring to FIG. 7, with the battery pack according to this embodiment, the battery 2 and the cover member 11 are fixed with a tape 24. This point is different from each of the foregoing embodiments. In addition, the connecting member and the battery 2 are maintained in an electrically connected state by separately screwing a screw 23 with the cover member 11 fixed by the tape 24. In other words, in this embodiment, the cover member 11 corresponds to the screw target of the screw 23.

Specifically, the battery pack according to this embodiment differs from the foregoing embodiments with respect to the following points. The point that the positive electrode 5 is disposed at the right edge of the upper end face of the battery 2. The point that a fixed part 19 and a lead plate 20 are provided in substitute for the lead plate 7. The point that a fixed part 21 and a lead plate 22 are provided in substitute for the lead plate 10. The point that the lead part 8a of the control member 8 and the insulating plate 9 are extending to the left edge of the battery 2. The point that a female screw part 11g is formed on the cover member 11 in substitute for the through-hole 11f. The point that a screw 23 is provided in substitute for the screw 12. The point that the cover member 11 and the battery 2 are fixed by a tape (fixing member) 24.

The fixed part 19 and the lead plate 20 configure the connecting member of this embodiment. In other words, the fixed part 19 is fixed to the printed circuit board 6 in a state of being electrically connected to wiring that is printed on the printed circuit board 6. The lead plate 20 is fixed to the fixed part 19 in a state of being electrically connected to the fixed part 19. Moreover, the lead plate 20 extends up to a position between the side wall 11b on the left side of the cover member 11 and the lead part 8a of the control member 8.

Similarly, the fixed part 21 and the lead plate 22 configure the connecting member of this embodiment. In other words, the fixed part 21 is fixed to the printed circuit board 6 in a state of being electrically connected to wiring of the printed circuit board 6. The lead plate 22 is fixed to the fixed part 21 in a state of being electrically connected to the fixed part 21. Moreover, the lead plate 22 extends up to a position between the side wall 11b on the right side of the cover member 11 and the positive electrode 5.

Note that, in this embodiment, the fixed part 19 and the lead plate 20 may be configured integrally. Similarly, the fixed part 21 and the lead plate 22 may be configured integrally.

The tape 24 restricts the relative movement of the battery 2 and the cover member 11 in the vertical, horizontal and depth directions. Specifically, the tape 24 is wrapped around the side wall of the battery and the cover member 11 in a state of extending across the battery 2 and the cover member 11.

In this embodiment, when the screw 23 inserted from above the counterbore 11e is screwed through the female screw part 11g of the cover member 11, the male screw part 23a of the screw 23 protrudes downward from the cover member 11. The lead plates 20, 22 are pressed against the control member 8 and the battery 2 by the male screw part 23a.

The method of manufacturing the battery pack of FIG. 7 is now explained.

Foremost, the fixed parts 19, 21 and the lead plates 20, 22 are respectively fixed. This process can be omitted when the fixed parts 19, 21 and the lead plates 20, 22 are configured integrally.

Subsequently, the printed circuit board 6 and the respective fixed parts 19, 21 are welded so that the wiring of the printed circuit board 6 and the fixed parts 19, 21 are electrically connected (first fixing step).

Subsequently, the insulating plate 9 is mounted on the upper face of the battery 2, and the control member 8 is mounted on the insulating plate 9 so as to electrically connect the functional element 8b of the control member 8 and the negative electrode 4 of the battery 2.

Subsequently, the lead plates 20, 22 are disposed (mounted) on the battery 2 so that the lead plate 20 comes in contact with the lead part 8a of the control member 8, and the lead plate 22 comes in contact with the positive electrode 5 of the battery 2 (arranging step).

Subsequently, the cover member 11 is mounted on the upper end face of the battery 2 so as to cover the printed circuit board 6, the respective fixed parts 19, 21 and the respective lead plates 20, 22 mounted on the battery 2 (mounting step). Subsequently, the cover member 11 and the battery 2 are fixed by wrapping the tape 24 around the side face of the cover member 11 and the battery 2 (second fixing step).

The screw 23 is screwed, from above, with the female screw part 11g of the cover member 11 (screwing step). In this screwing step, the lead plates 20, 22 is pressed against the battery 2 according to the movement of the tip part of the screw 23 (male screw part 23a). Consequently, the electrically connected state of the lead plate 20 to the lead part 8a of the control member 8 is maintained, and the electrically connected state of the lead plate 22 to the positive electrode 5 of the battery 2 is maintained.

In the foregoing embodiment, the screw 23 is screwed through the female screw part 11g of the cover member 11 that is fixed to the battery 2 by the tape 24. It is thereby possible to press the lead plates 20, 22 so as to maintain the electrically connected state to the battery 2.

Note that, in each of the foregoing embodiments, a connecting member is connected to the negative electrode 4 via the control member 8 and a connecting member is directly connected to the positive electrode 5. Nevertheless, the configuration is not limited thereto. For example, opposite to each of the foregoing embodiments, the configuration may also be such that a connecting member is connected to the negative electrode 4 and a connecting member is connected to the positive electrode 5 via the control member.

Moreover, although the cover member 11 is provided in each of the foregoing embodiments, the cover member 11 is not an essential component. For example, the connecting member and the battery 2 can also be directly fixed based on the screwing of a screw.

Note that the specific embodiments described above mainly include the inventions configured as follows.

In order to achieve the foregoing object, the present invention provides a battery pack comprising a battery, and a safety member that includes a circuit connected to the battery and that controls the circuit when a predetermined cause is detected, wherein the safety member comprises: a substrate including wiring which configures at least a part of the circuit; a connecting member that is fixed to the substrate and that electrically connects the wiring and a pole of the battery; and a screw that maintains an electrically connected state of the connecting member to the pole of the battery by being screwed into a predetermined screw target.

Moreover, the present invention provides a method of manufacturing a battery pack, including a first fixing step of fixing a connecting member and a substrate so that wiring formed on the substrate and the connecting member are electrically connected; an arranging step of arranging the connecting member fixed to the substrate at a position where the connecting member is electrically connected to a pole of battery; a mounting step of mounting a cover member on the battery so as to cover the substrate and the connecting member arranged in the arranging step; and a second fixing step of fixing the cover member to the battery by screwing a screw into the battery through the cover member mounted on the battery, wherein in the second fixing step, a state of electrically connecting of the connecting member to the pole of battery is maintained by pressing the connecting member to the battery side via the cover member in accordance with the screwing of the screw.

In addition, the present invention provides a method of manufacturing a battery pack, including a first fixing step of fixing a connecting member and a substrate so that wiring formed on the substrate and the connecting member are electrically connected; an arranging step of arranging the connecting member fixed to the substrate at a position where the connecting member is electrically connected to a pole of battery; a mounting step of mounting a cover member on the battery so as to cover the substrate and the connecting member arranged in the arranging step; a second fixing step of fixing the battery and the cover member so as to restrict the battery and the cover member from moving in a direction of mutual separation; and a screwing step of screwing a screw through the cover member fixed to the battery, wherein in the screwing step, a state of electrically connecting of the connecting member to the pole of the battery is maintained by pressing the connecting member to the battery side in accordance with the movement of a tip part of the screw.

According to the foregoing inventions, the electrically connected state of the connecting member and the battery can be maintained by the screwing of a screw. It is thereby possible to streamline the assembly work of the battery pack. Specifically, the connected state of the connecting member and the battery can be maintained by the screwing of the screw in a state of fixing the substrate and the connecting member in advance, and arranging the connecting member fixed to the substrate at a position where the connecting member and the battery can be electrically connected. Thus, it is possible to eliminate the complicated process of performing welding on both sides (battery side and substrate side) of the connecting member, and streamline the assembly work.

In the foregoing battery pack, preferably, the safety member further comprises a cover member which covers the substrate and the connecting member, the screw fixes the cover member to the battery by being screwed into the battery, and the connecting member is pressed to the battery side as a result of the substrate being pressed via the cover member in accordance with the screwing of the screw.

According to the foregoing configuration, the screw for pressing the connecting member to the battery side can also be used for fixing the cover member and the battery. Thus, the number of parts can be reduced.

In the foregoing battery pack, preferably, the screw includes a male screw part and a head part, the cover member includes a through-hole through which the male screw part is inserted and a counterbore for housing the head part, and the counterbore is provided with restrictive means for restricting contact from the outside of the cover member to the head part.

According to the foregoing configuration, contact to the head part of the screw is restricted by the restrictive means. Thus, it is possible to inhibit the operation of loosening the screw from the outside of the cover member. Accordingly, the electrically connected state of the connecting member and the pole of the battery can be maintained more effectively.

In the foregoing battery pack, preferably, the connecting member is pressed to the battery side while at least a part of the connecting member is subject to elastic deformation between the battery and the substrate in accordance with the screwing of the screw.

According to the foregoing configuration, at least a part of the connecting member will be pressed to the battery side with the connecting member in an elastically deformed state in accordance with the screwing of the screw. Thus, even in cases where the distance between the connecting member and the counterpart member is changed such as when impact is applied to the battery pack, the connecting member is subject to elastic deformation in accordance with such change. It is thereby possible to reliably maintain the electrically connected state.

In the foregoing battery pack, preferably, the connecting member includes a body part fixed to the substrate, and a protruding part protruding from the body part to the battery side.

According to the foregoing configuration, the connecting member includes a protruding part protruding to the battery side. Thus, by pressing the connecting member to the battery side, the protruding part can be caused to actively come in contact while preventing an unintended portion (for instance, the body part) of the connecting member from coming in contact with the counterpart member. Moreover, the contact area can be decreased by causing the protruding part, which is a part of the connecting member, to come in contact with the counterpart member in comparison to the case of causing the entire connecting member to come in contact. Thus, the contact pressure of the connecting member and the counterpart member can be increased.

In the foregoing battery pack, preferably, the safety member further comprises a control member that is connected to the pole of the battery and that configures a part of the circuit, and controls the circuit by switching between a state of connection to the battery and a state of disconnection from the battery when the temperature of the battery becomes a predetermined temperature or higher, and the connecting member is electrically connected to the control member in accordance with the screwing of the screw.

According to the foregoing configuration, the thermal runaway and the like of the battery can be inhibited by the control member switching from the connected state of the battery to the disconnected state of the battery when the temperature of the battery becomes a predetermined temperature or higher. In addition, the connecting member and the battery can be electrically connected via the control member.

In the foregoing battery pack, preferably, the safety member further comprises a cover member that covers the substrate and the connecting member, and a fixing member that fixes the cover member to the battery, the cover member is provided with a female screw part which penetrates the cover member and with which the screw is screwed, and the connecting member is pressed by a tip part of the screw which protrudes from the cover member in accordance with the screwing with the female screw part.

According to the foregoing configuration, the connecting member can be pressed against the battery so as to maintain the electrically connected state by fixing the battery and the cover member with the fixing member, and subsequently screwing the screw with the female screw part of the cover member.

### INDUSTRIAL APPLICABILITY

According to the present invention, it is possible to streamline the assembly work of the battery pack.

### EXPLANATION OF REFERENCE NUMERALS

1 battery pack
2 battery
3 safety member
4 negative electrode
5 positive electrode
6 printed circuit board
7, 10 lead plate
8 control member
11 cover member
11a top plate
11b side wall
11e counterbore
11g female screw part
12 screw
12a male screw part
12b head part
14a body part
14b protruding part
15a body part
15b tongue part
16 connecting terminal
18a body part
18b protruding part
19, 21 fixed part
20, 22 lead plate
24 tape (fixing member)
30 restrictive member (restrictive means)

1. A battery pack comprising a battery, and a safety member that includes a circuit connected to the battery and that controls the circuit when a predetermined cause is detected, wherein
the safety member comprises:
a substrate including wiring which configures at least a part of the circuit;
a connecting member that is fixed to the substrate and that electrically connects the wiring and a pole of the battery; and
a screw that maintains an electrically connected state of the connecting member to the pole of the battery by being screwed into a predetermined screw target, wherein
the safety member further comprises a cover member that covers the substrate and the connecting member, and a fixing member that fixes the cover member to the battery,
the cover member is provided with a female screw part that penetrates the cover member and with which the screw is screwed, and
the connecting member is pressed by a tip part of the screw that protrudes from the cover member in accordance with the screwing with the female screw part.

2. (canceled)

3. The battery pack according to claim 1, wherein
the screw includes a male screw part and a head part,
the cover member includes a through-hole through which the male screw part is inserted and a counterbore for housing the head part, and
the counterbore is provided with restrictive means for restricting contact from the outside of the cover member to the head part.

4. The battery pack according to claim 1, wherein the connecting member is pressed to the battery side while at least a part of the connecting member is subject to elastic deformation between the battery and the substrate in accordance with the screwing of the screw.

5. The battery pack according to claim 1, wherein the connecting member includes a body part fixed to the substrate, and a protruding part protruding from the body part to the battery side.

6. The battery pack according to claim 1, wherein
the safety member further comprises a control member that is connected to the pole of the battery and that configures a part of the circuit, and controls the circuit by switching between a state of connection to the battery and a state of disconnection from the battery when a temperature of the battery becomes a predetermined temperature or higher, and
the connecting member is electrically connected to the control member in accordance with the screwing of the screw.

7. (canceled)

8. (canceled)

9. A method of manufacturing a battery pack, including:
a first fixing step of fixing a connecting member and a substrate so that wiring formed on the substrate and the connecting member are electrically connected;
an arranging step of arranging the connecting member fixed to the substrate at a position where the connecting member is electrically connected to a pole of battery;
a mounting step of mounting a cover member on the battery so as to cover the substrate and the connecting member arranged in the arranging step;
a second fixing step of fixing the battery and the cover member by a fixing member so as to restrict the battery and the cover member from moving in a direction of mutual separation; and
a screwing step of screwing a screw through the cover member fixed to the battery, wherein
in the screwing step, a state of electrically connecting of the connecting member to the pole of the battery is maintained by pressing the connecting member to the battery side in accordance with the movement of a tip part of the screw.
